(19) United States
(12) Patent Application Publication
(10) Pub. No.: US 2006/0262103 A1
(43) Pub. Date: Nov. 23, 2006

(54) Human machine interface method and device for cellular telephone operation in automotive infotainment systems

(75) Inventors: Hongxing Hu, West Bloomfield, MI (US); Jie Chen, Windsor (CA)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/438,016

(22) Filed: May 19, 2006

Related U.S. Application Data
(63) Continuation-in-part of application No. 11/384,923, filed on Mar. 17, 2006.
Application No. 11/384,923 is a continuation-in-part of application No. 11/119,402, filed on Apr. 29, 2005.
(60) Provisional application No. 60/669,951, filed on Apr. 8, 2005.

(51) Int. Cl. G09G 5/00

(52) U.S. Cl. 345/173

(57) ABSTRACT

A system for controlling cellular telephone from within a vehicle, includes a cell phone interface disposed within the vehicle and configured to establish data communication with a cellular telephone disposed within the vehicle. A touchpad supplies input from a vehicle occupant including at least motion vectors. A control unit coupled to the cell phone interface effects data communication with the cellular telephone via the cell phone interface at least in part in response to the motion vectors.

### CROSS-REFERENCE TO RELATED APPLICATIONS

This application is a continuation-in-part of U.S. patent application Ser. No. 11/384,923 filed on Mar. 17, 2006, which is a continuation-in-part of U.S. patent application Ser. No. 11/119,402 filed on Apr. 29, 2005, which claims the benefit of U.S. Provisional Application No. 60/669,951, filed on Apr. 8, 2005. The disclosures of the above applications are incorporated herein by reference in their entirety for any purpose.

### FIELD

The present invention relates to human machine interfaces and, more particularly, to an improved control interface for a driver of a vehicle.

### BACKGROUND

The statements in this section merely provide background information related to the present disclosure and may not constitute prior art.

Market research has shown that operating a handheld cellular phone while driving is one of the most common causes of distractions that can significantly increase the risk of crashes. As a solution, many automotive vehicle manufactures now offer hands free cellular telephone capability, whereby the vehicle occupant can place and answer cellular telephone calls without the need to press tiny buttons or read the tiny display of the cellular telephone device. Hands free cellular telephone features are usually incorporated into the vehicle's audio system and include basic speech recognition capability, so that the user can issue dialing commands by voice.

Some hands free systems actually embed cellular telephone transmitting and receiving equipment within the audio system of the vehicle. In these systems, the user must typically subscribe to a special cellular telephone service, which may be in addition to the user's personal cellular telephone service. In other systems, the user's existing cellular telephone (and cellular telephone account) are integrated with the vehicle audio system via a Bluetooth wireless connection. In these wireless systems, the cellular telephone must have Bluetooth wireless capability, and also the ability to support the hands free protocols used by the vehicle audio system. In these wireless systems, the user provides dialing commands (or answering commands) by speaking. The vehicle audio system employs a speech recognizer that interprets the user's speech and issues (via Bluetooth) the necessary hands free commands to cause the user's cellular telephone to initiate (or answer) a call. Once the call is established, the conversation is routed (via Bluetooth) to the audio system, so the user can hold the conversation by simply speaking within the vehicle and without the need to physically handle the cellular phone. The phone can be kept in the user's pocket or purse, or anywhere within Bluetooth range of the vehicle audio system.

While hands free capability is quite popular, current systems are far from perfect. Menu navigation and phonebook navigation are two weak points. In conventional systems, the user navigates through a menu of command choices and phonebook entries by issuing voice commands. However, the vehicle is a particularly noisy environment where speech recognition systems may not perform well. To address this, most speech recognition systems support only a limited number of commands. Selection of names from a lengthy phonebook may simply not be possible, due to the likelihood of confusion between similar sounding names.

The present invention addresses this shortcoming by employing a touchpad with character/stroke recognition capability by which menu navigation and phonebook name selection can be made by hand drawing characters on the touchpad with the fingertip. The touchpad can be used alone or in conjunction with speech to give the user excellent control over navigation choices.

### SUMMARY

A system for controlling cellular telephone from within a vehicle, includes a cell phone interface disposed within the vehicle and configured to establish data communication with a cellular telephone disposed within the vehicle. A touchpad supplies input from a vehicle occupant including at least motion vectors. A control unit coupled to the cell phone interface effects data communication with the cellular telephone via the cell phone interface at least in part in response to the motion vectors.

In some embodiments, the system may include a visual display, such as a heads up display or other secondary display unit on dash board, driving information center or rear view mirror as example, or a panel display of the type used in vehicle navigation systems. The visual display may be used to present menu navigation choices and phonebook choices to the user, where navigation is performed using the touchpad. If desired, the visual display can also function as a media viewer to display media content stored in the cellular telephone, in a media player (e.g., iPod) attached to the vehicle audio system, or in a media storage system integrated with the vehicle audio system.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an exemplary perspective view of the instrument panel of a vehicle, showing a typical environment in which the human machine interface for automotive entertainment system may be deployed.

FIG. 2 is a plan view of an exemplary steering wheel, illustrating the multifunction selection switches and multifunction touchpad components.

FIG. 3 is a block diagram illustrating hardware and software components that may be used to define the human machine interface for hands free cellular telephone operation.

FIG. 4 is a functional block diagram illustrating certain functional aspects of the human machine interface, including the dynamic prompt system and character (stroke) input system, and further including the cell phone interface and video interface.

FIG. 5 is a flow diagram illustrating sequential views of displays of the user interface during user selection and employment of a search mode.

FIG. 6 is a flow diagram illustrating sequential views of displays of the user interface in response to user manipulation of a touchpad switch component of the user interface during user employment of a number entry mode.

FIG. 7 is a flow diagram illustrating sequential views of displays of the user interface in response to user manipulation of a touchpad switch component of the user interface during employment of an ordered list element selection mode.

FIG. 8 is a flow diagram illustrating sequential views of displays of the user interface in response to user manipulation of a touchpad switch component of the user interface during employment of an alphabetized list element selection mode.

FIG. 9 is a flow diagram illustrating a method of user selection of an alphabetized list element using a combination of user manipulation of a touchpad switch component of the user interface and a user speech input.

### DETAILED DESCRIPTION

The following description is merely exemplary in nature and is not intended to limit the present disclosure, application, or uses. It should be understood that throughout the drawings, corresponding reference numerals indicate like or corresponding parts and features.

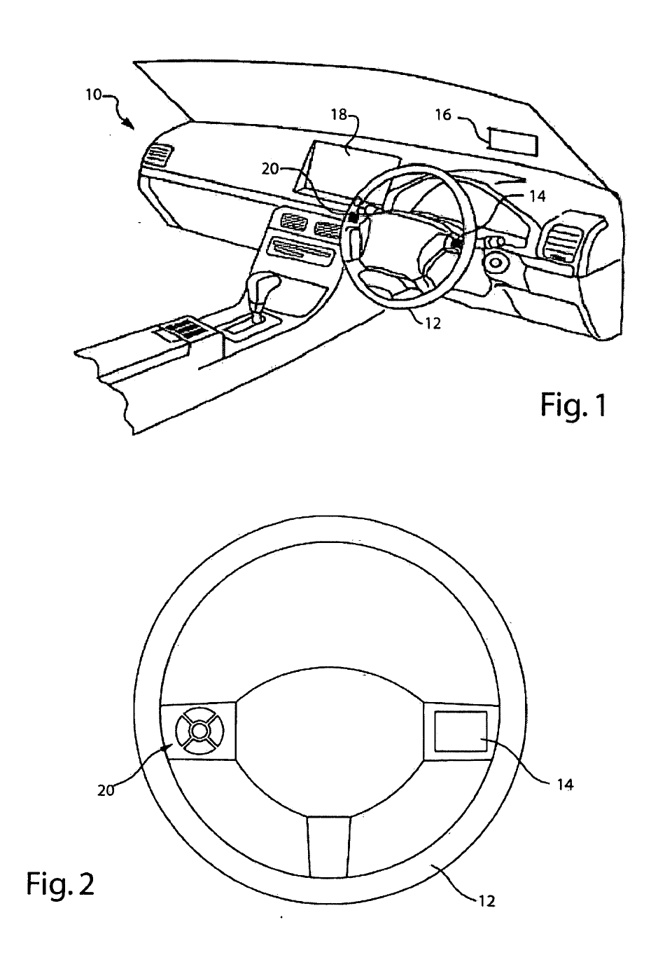

FIG. 1 illustrates an improved human machine interface for automotive entertainment systems in an exemplary vehicle cockpit at 10. The human machine interface allows a vehicle occupant, such as the driver, to control audio-video components mounted or carried within the vehicle, portable digital players, vehicle mounted digital players and other audio-video components.

The human machine interface includes, in a presently preferred embodiment, a collection of multifunction switches 20 and a touchpad input device 14 that are conveniently mounted on the steering wheel 12. As will be more fully explained, the switches and touchpad are used to receive human input commands for controlling the audio-video equipment and selecting particular entertainment content. The human machine interface provides feedback to the user preferably in a multimodal fashion. The system provides visual feedback on a suitable display device. In FIG. 1, two exemplary display devices are illustrated: a heads-up display 16 and a dashboard-mounted display panel 18. The heads-up display 16 projects a visual display onto the vehicle windshield. Display panel 18 may be a dedicated display for use with the automotive entertainment system, or it may be combined with other functions such as a vehicle navigation system function. Of course, various kinds of displays can be employed. For example, another kind of display can be a display in the instrument cluster. Still another kind of display can be a display on the rear view mirror.

If desired, the operation functionality of the touchpad can be user-configurable. For example, some people like to search by inputting the first character of an item, while others like to use motion to traverse a list of items. Also, people who are generally familiar with an interface of a particular media player can select to cause the touchpad to mimic the interface of that media player. In particular, switches embedded in locations of the touchpad can be assigned functions of similarly arranged buttons of an iPod™ interface, including top for go back, center for select, left and right for seek, and bottom for play&pause. Yet, users familiar with other kinds of interfaces may prefer another kind of definition of switch operation on the touchpad. It is envisioned that the user can select a template of switch operation, assign individual switches an operation of choice, or a combination of these.

FIG. 2 shows the steering wheel 12 in greater detail. In the preferred embodiment, the touchpad input device 14 is positioned on one of the steering wheel spokes, thus placing it in convenient position for input character strokes drawn by the fingertip of the driver. The multifunction switches 20 are located on the opposite spoke. If desired, the touchpad and multifunction switches can be connected to the steering wheel using suitable detachable connectors to allow the position of the touchpad and multifunction switches to be reversed for the convenience of left handed persons. The touchpad may have embedded pushbutton switches or dedicated regions where key press selections can be made. Typically such regions would be arranged geometrically, such as in the four corners, along the sides, top and bottom and in the center. Accordingly, the touchpad input device 14 can have switch equivalent positions on the touchpad that can be operated to accomplish the switching functions of switches 20. It is envisioned that the touchpad can be used to draw characters when a character is expected, and used to actuate switch functions when a character is not expected. Thus, dual modes of operation for the touchpad can be employed, with the user interface switching between the modes based on a position in a dialogue state machine.

The human machine interface concept can be deployed in both original equipment manufacture (OEM) and aftermarket configurations. In the OEM configuration it is frequently most suitable to include the electronic components in the head unit associated with the entertainment system. In an aftermarket configuration the electronic components may be implemented as a separate package that is powered by the vehicle electrical system and connected to the existing audio amplifier through a suitable audio connection or through a wireless radio (e.g., FM radio, Bluetooth) connection.

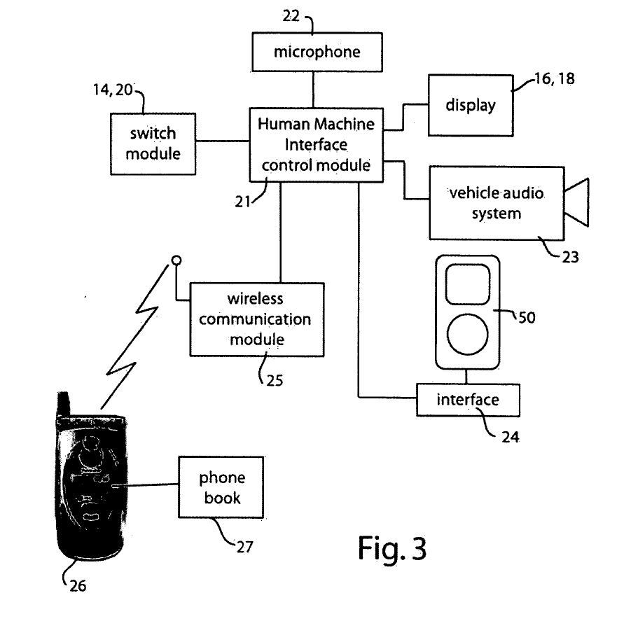

FIG. 3 shows the basic components of an implementation to support hands free control of a cellular telephone 26 using the touchpad. The switch module (comprising support for various switches such as switches 14 and 20) is coupled to the human machine interface control module 21. Also coupled to control module 21 is the display (such as display 14 and/or display 18), as well as the vehicle audio system 23. To support spoken commands, a microphone 22 is also coupled to the control module 21. Although not necessary to support hands free control of the cellular telephone 26, a dock interface 24 is also shown in FIG. 3, to illustrate how the control module 21 can also be connected to media players, such as iPod™ 50.

In a presently preferred embodiment, a wireless communication module 25 is coupled to the control module 21 and provides wireless communication with cellular phone 26. In one embodiment, Bluetooth communication is employed. Of course, other wireless or wired communication links are also possible. The wireless link supports bi-directional communication of both control commands and speech communication data, as well as other forms of data.

The cellular telephone 26 may include an internal phonebook 27, containing phone numbers previously stored by the user in the cellular telephone memory. The control module 21 can provide search commands to the cellular phone, causing the phonebook to be searched for a desired number to be dialed. In an alternate embodiment, a copy of the phonebook 27 can be made and stored within memory managed by the control module 21. The control module can then send a dial instruction to the phone to initiate dialing. Once the call is established, the two-way voice communication between the user and the other party are sent via the wireless connection so that the microphone 22 can be used to receive the user's speech and the vehicle audio system 23 can be used to make audible the other party's speech.

The wireless communication module can also support other forms of data transmission, such as for audio/video playback of media content stored in the cellular telephone. Current Bluetooth technology will support bit rates up to approximately 192 bits per second. Future extensions of this technology are expected to provide higher bit rates, allowing even higher quality audio and video to be sent wirelessly to the control module 21. Current IEEE 802.11 (WiFi) wireless communication technology supports even higher data rates and may also be used where wireless transmission of video is desired. In this regard, where the stored media includes video content, that content can be played back on the display 16, 18.

The hands free operation of the cellular telephone can follow many of the same navigational patterns (and gestural dialogues) used to control the media player. Moreover, both the cellular telephone and the media play can store media content that may be played back using the vehicle audio system. Thus the user does not really need to care which device is being controlled. If media playback is desired, either the cellular phone or the media player can provide that content. The user interface (touchpad control) remains essentially the same. If the user wishes to obtain information from a personal information manager (PIM) feature of the cellular phone or media player, again, the user simply requests that information through touchpad control. The control module 21 is designed to integrate all devices, so that the user does not have to worry about which device he or she needs to interact with to obtain the desired results.

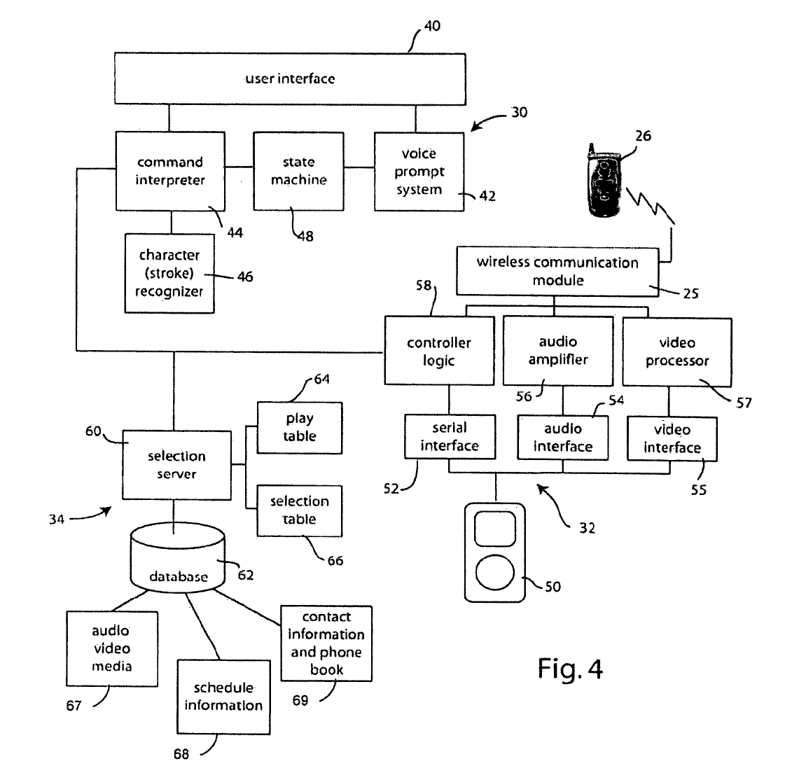

FIG. 4 depicts an exemplary embodiment that may be adapted for either OEM or aftermarket use. In this implementation, the human machine interface control module 21 (FIG. 3) employs three basic subsections: a human machine interface subsection 30, a digital media player interface subsection 32, and a database subsection 34. The human machine interface subsection includes a user interface module 40 that supplies textual and visual information through the displays (e.g., heads-up display 16 and display panel 18 of FIG. 1). The human machine interface also includes a voice prompt system 42 that provides synthesized voice prompts or feedback to the user through the audio portion of the automotive entertainment system.

Coupled to the user interface module 40 is a command interpreter 44 that includes a character or stroke recognizer 46 that is used to decode the hand drawn user input from the touchpad input device 14. A state machine 48 (shown more fully in FIG. 4) maintains system knowledge of which mode of operation is currently invoked. The state machine works in conjunction with a dynamic prompt system that will be discussed more fully below. The state machine controls what menu displays are presented to the user and works in conjunction with the dynamic prompt system to control what prompts or messages will be sent via the voice prompt system 42.

The state machine can be reconfigurable. In particular, there can be different search logic implementations from which the user can select one to fit their needs. For example, when trying to control the audio program, some people need to access the control of the audio source (e.g., FM/AM/satellite/CD/ . . . ) most often, so these controls can be provided at a first layer of the state machine. On the other hand, some people need to access the equalizer most often, so these controls can be provided at the first layer.

The digital media player subsection 32 is shown making an interface connection with a portable media player 50, such as an iPod™. For iPod™ connectivity, the connection is made through the iPod™ dock connector. For this purpose, a serial interface 52, an audio interface 54, and a video interface 55 are provided. The iPod™ dock connector supplies both serial (USB) and audio signals through the dock connector port. The signals are appropriately communicated to the serial interface and audio interface respectively. The audio interface 54 couples the audio signals to the audio amplifier 56 of the automotive entertainment system. Serial interface 52 couples to a controller logic module 58 that responds to instructions received from the human machine interface subsection 30 and the database subsection 34 to provide control commands to the media player via the serial interface 52 and also to receive digital data from the media player through the serial interface 52. The video interface 55 couples to a video processor 57 that renders stored video data so that it can be displayed on the vehicle display (e.g., on the display 18 (FIG. 1).

The wireless communication module 25 couples to each of the controller logic 58, the audio amplifier 56, and the video processor 57, so that control commands and audio/video data can be input and output via the wireless link.

The database subsection 34 includes a selection server 60 with an associated database 62. The database stores a variety of information, including audio and video playlist information and other metadata reflecting the contents of the media player (e.g., iPod™ 50) or of the cellular phone 26 if it also stores media content. The playlist data can include metadata for various types of media, including audio, video, information of recorded satellite programs, or other data. Database 62 may also store contact information, schedule information and phonebook information (downloaded from the memory of the cellular phone 26, from the media player 50, or from some other information management device or Internet site.

For hands free cellular phone operation, the selection server 60 responds to instructions from command interpreter 44 to initiate database lookup operations using a suitable structured query language (SQL). The lookup operation may return a phone number of a requested party, which can be displayed on the display screen, or provided verbally through text-to-speech synthesis or other voice response prompting.

For media playback, the selection server 60 responds to instructions from command interpreter 44 to initiate database lookup operations using a suitable structured query language (SQL). The selection server populates a play table 64 and a selection table 66 based on the results of queries made of the song database at 62. The selection table 66 is used to provide a list of items that the user can select from during the entertainment selection process. The play table 64 provides a list of media selections or songs to play. The selection table is used in conjunction with the state machine 48 to determine what visual display and/or voice prompts will be provided to the user at any given point during the system navigation. The play table provides instructions that are ultimately used to control which media content items (e.g., songs) are requested for playback by the media player (iPod).

When the media player is first plugged in to the digital media player subsection 32, an initializing routine executes to cause the song database 62 to be populated with data reflecting the contents of the media player. Specifically, the controller logic module 58 detects the presence of a connected media player. Then, the controller logic module can send a command to the media player that causes the media player to enter a particular mode of operation, such as an advanced mode. Next, the controller logic module can send a control command to the media player requesting a data dump of the player's playlist information, including artist, album, song, genre and other metadata used for content selection. If available, the data that is pumped can include the media player's internal content reference identifiers for accessing the content described by the metadata. The controller logic module 58 routes this information to the selection server 60, which loads it into the song database 62. It is envisioned that a plurality of different types of ports can be provided for connecting to a plurality of different types of media players, and that controller logic module 58 can distinguish which type of media player is connected and respond accordingly. It is also envisioned that certain types of connectors can be useful for connecting to more than one type of media player, and that controller logic module can alternatively or additionally be configured to distinguish which type of media player is connected via a particular port, and respond accordingly.

It should be readily understood that some media players can be capable of responding to search commands by searching using their own interface and providing filtered data. Accordingly, while it is presently preferred to initiate a data dump to obtain a mirror of the metadata on the portable media player, and to search using the constructed database, other embodiments are also possible. In particular, additional and alternative embodiments can include searching using the search interface of the portable media player by sending control commands to the player, receiving filtered data from the player, and ultimately receiving selected media content from the player for delivery to the user over a multimedia system of the vehicle.

As might be expected, in a moving vehicle it can sometimes be difficult to neatly supply input characters. To handle this, the recognition system is designed to work using probabilities, where the recognizer calculates a likelihood score for each letter of the alphabet, representing the degree of confidence (confidence level) that the character (stroke) recognizer assigns to each letter, based on the user's input. Where the confidence level of a single character input is high, the results of that single recognition may be sent directly to the selection server 60 (FIG. 4) to retrieve all matching selections from the database 62. However, if recognition scores are low, or if there is more than one high scoring candidate, then the system will supply a visual and/or verbal feedback to the user that identifies the top few choices and requests the user to pick one. Thus, when the character or stroke input mechanism 92 is used, the input character is interpreted at 96 and the results are optionally presented to the user to confirm at 98 and/or select the correct input from a list of the n-most probable interpretations.

It should be readily understood that vector (stroke) data can be used to train hidden Markov models or other vector-based models for recognizing handwritten characters. In such cases, user-independent models can be initially provided and later adapted to the habits of a particular user. Alternatively or additionally, models can be trained for the user, and still adapted over time to the user's habits.

It is envisioned that models can be stored and trained for multiple drivers, and that the drivers' identities at time of use can be determined in a variety if ways. For example, some vehicles have different key fobs for different users, so that the driver can be identified based on detection of presence of a particular key fob in the vehicle. Also, some vehicles allow drivers to save and retrieve their settings for mirror positions, seat positions, radio station presets, and other driver preferences; thus the driver identity can be determined based on the currently employed settings. Further, the driver can be directly queried to provide their identity. Finally, the driver identity can be recognized automatically by driver biometrics, which can include driver handwriting, speech, weight in the driver's seat, or other measurable driver characteristics.

It should also be readily understood that the aforementioned human machine interface can be employed to provide users access to media content that is stored in memory of the vehicle, such as a hard disk of a satellite radio, or other memory. Accordingly, users can be permitted to access media content of different system drives using the human machine interface, with a media player temporarily connected to the vehicle being but one type of drive of the system. Moreover, the system can be used to allow users to browse content available for streaming over a communications channel. As a result, a consistent user experience can be developed and enjoyed with respect to various types of media content available via the system in various ways.

The operations described above for interacting with a media player can be extended to interaction with a cellular telephone by wired or wireless connection, such as by Bluetooth. For example, it is envisioned that any cellular telephone that is compatible with hands free operation can be dialed remotely using a touchpad. Also, it is envisioned that some cellular telephones can be capable of responding to search queries by providing menu and database contents that are filtered based on the search queries. Further, it is envisioned that some cellular telephones can be capable of permitting a data pump to be performed in order to download either or both of the cellular telephone's menu structure and/or data, such as incoming, outgoing, and missed calls, contact information and phone book contents 69, text messages, emails, pictures, music, video media 67, and schedule information 68 to database 62 in a hard drive of the vehicle. Accordingly, the user interface of the vehicle can obtain a copy of index data from the media device (portable media player and/or cellular telephone) and allow the user to browse the copy in database 62, or can directly query the media device for filtered data, depending on the capabilities of the media device. Therefore it is envisioned that the cellular telephone can be accessed and controlled by the user interface integrated into the vehicle, or at least directly dialed by the user interface of the vehicle.

Some primary operations of such a system are to perform menu navigation, incoming call receiving (e.g., connect, direct to voice mail), outgoing call dialing (e.g., phone book search, recent outgoing call, recent incoming call, direct dial), and media play/search. Accordingly, some embodiments of the system can include ECU or PC software in order to: (a) host phone control logic and control Bluetooth cell phone based on switch input; (b) host OCR engine, read and interpret switch action; (c) use recognized character/motion to search audio/BT phone database; (d) send the info for both display units and info for voice feedback to head unit in cell phone control mode. Similarly some embodiments of the system can include a head unit to: (a) host audio control logic and drive radio based on switch input; (b) interface to iPod™ to search based on the method and character from switch input; (c) drives an LCD display and a secondary display; and (d) generate voice feedback.

Some features provided by some embodiments of the system include: (a) full control of the cell phone including: (1) control multimedia and search program by different method; (2) receive/make/terminate calls by various methods; (3) use organizer, Microsoft office tool, etc.; (b) quick data search by using of a touchpad switch with finger-writing character input capability; (c) secondary display on dash or other easy seeing locations, and voice feedback combined to assist menu navigation and control operations; and (d) voice feed back provides additional assistance. Some benefits of some embodiments of the system include: (a) a new user friendly interface for hands-free cell phone operation during driving in order to improve operation convenience, reduce driver distraction and workload, and improve drive safety; (b) design simplification achieving improved reliability as compared to speech recognition based solutions, and potential cost reduction; and (c) potential for combination with speech recognition for more powerful functions.

Supported Bluetooth cell phone operations can include phone calls, multimedia, and organizer and Internet connection operations. For example, supported phone call operations can include: (a) receiving incoming calls; (b) making a call by inputting a phone number by each digit, browsing and searching address book, browsing and searching call history (incoming, outgoing, missed calls); (c) terminate a call/Cancel an outgoing call before connection established; (d) mute/un-mute audio system automatically depending on the cell phone status; (e) view incoming text message; (f) send text message; and (g) synchronize address book and call history dynamically between PC/ECU and Bluetooth cell phone. Also, supported multimedia operations can include: (a) control mp3 player on cell phone and search mp3 files by different search methods through iTunes™; (b) control radio on cell phone and seek different stations in AM/FM/Satellite; (c) control TV on cell phone and seek different stations including satellite TV station; (d) control the video player and search the video program to play; (e) control camera on cell phone to snap a picture and send the picture; and (f) play games on cell phone. Further, organizer and Internet connection operations can include: (a) view incoming email; (b) compose and send email by browsing and searching inbox emails and/or browsing and searching contact list; (c) view calendar and tasks; (d) compose document in Microsoft Word™, Excel™, and PowerPoint™; (e) surf the Internet, read news, download music, receive dynamic message on sports, stocks, etc. and view the message; and (f) play online games.

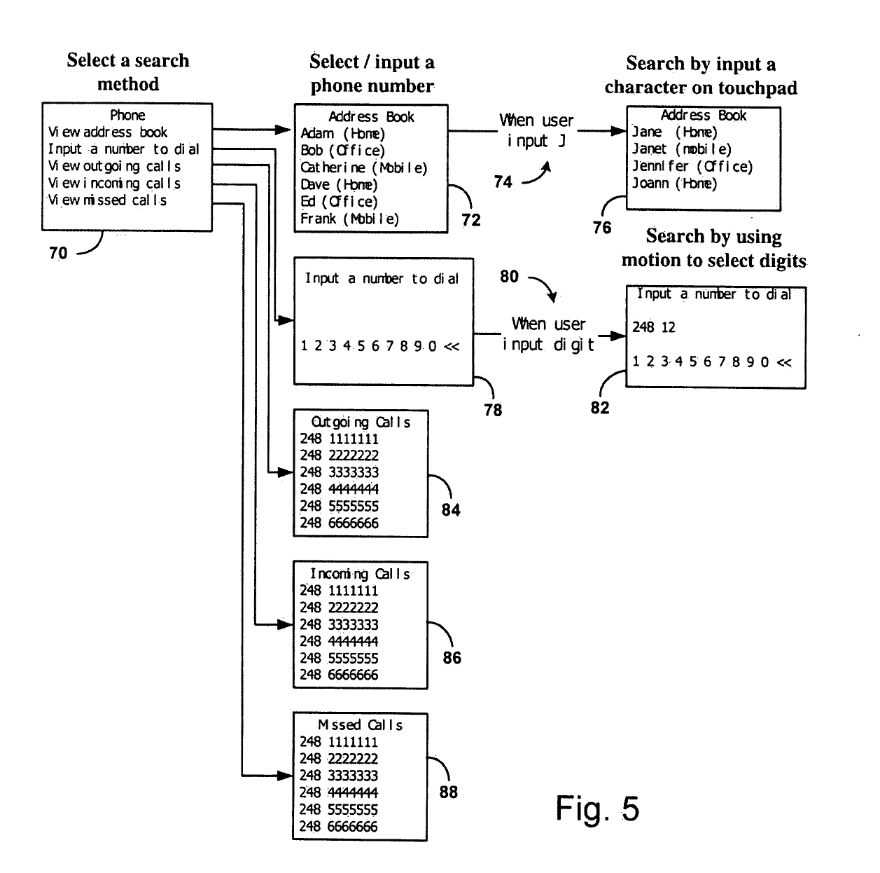

Turning now to FIGS. 5-9, the user search operations for performing database lookup and direct dialing during hands free cellular phone operation are explored in more detail. Beginning with FIG. 5, it is envisioned that the user can search contents of the cellular telephone in a number of ways. For example, the user can select one of several search methods to employ at 70. This selection can be made by the user selecting a set of information to search, such as whether to view the address book, input a number to dial, view outgoing calls, view incoming calls, or view missed calls. In the case the user selects to view the address book, the contents of the address book are displayed at 72. Then, when the user draws a letter on the touchpad as at 74, the contents of the address book are searched by the input of the letter.

If the user selects to input a number to dial, then a range of numerical inputs is displayed as at 78. The user is allowed to search and select digits by motion on the touchpad as at 80. These digits are then used to construct a phone number to dial as at 82.

If the user selects to view the list of incoming, outgoing, or missed calls, then a list of incoming calls 84, outgoing calls 86, or missed calls 88 is displayed to the user. The user is then permitted to select a member of the list by pressing a designated control to move forward or backward in the list or by using motion on the touchpad. The selected number is then used to make a telephone call.

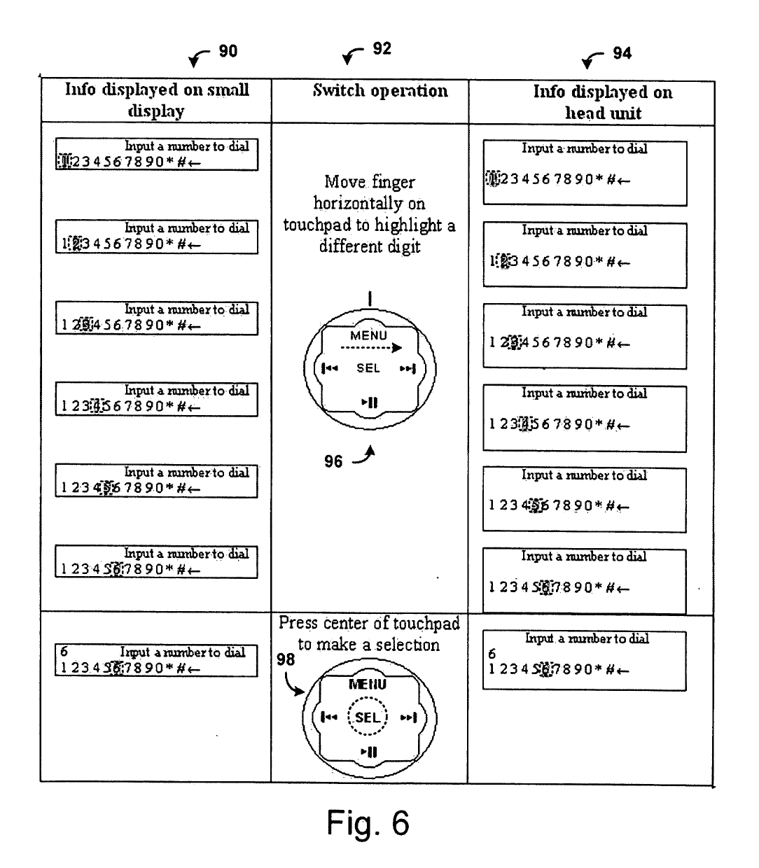

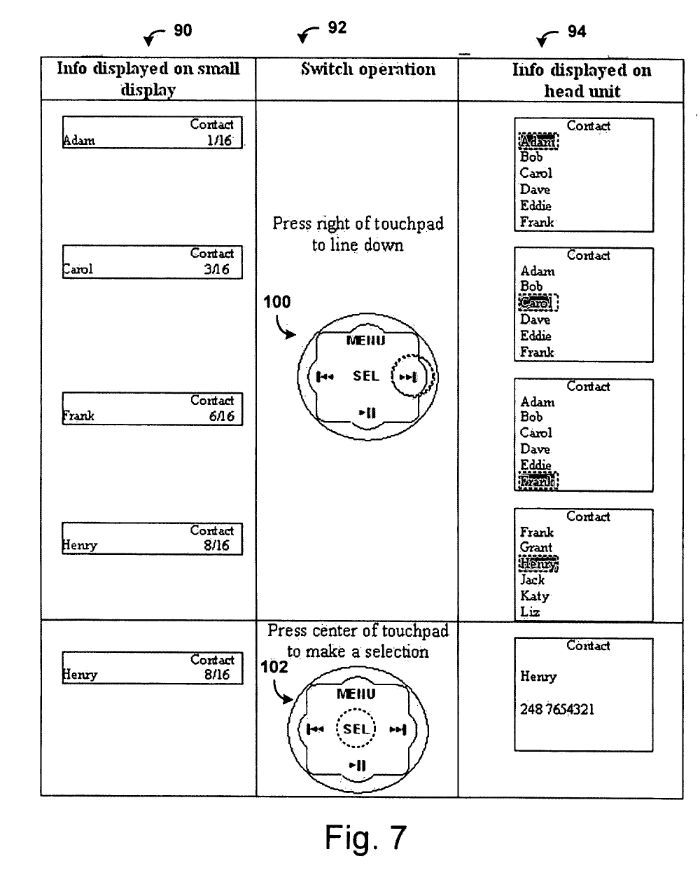

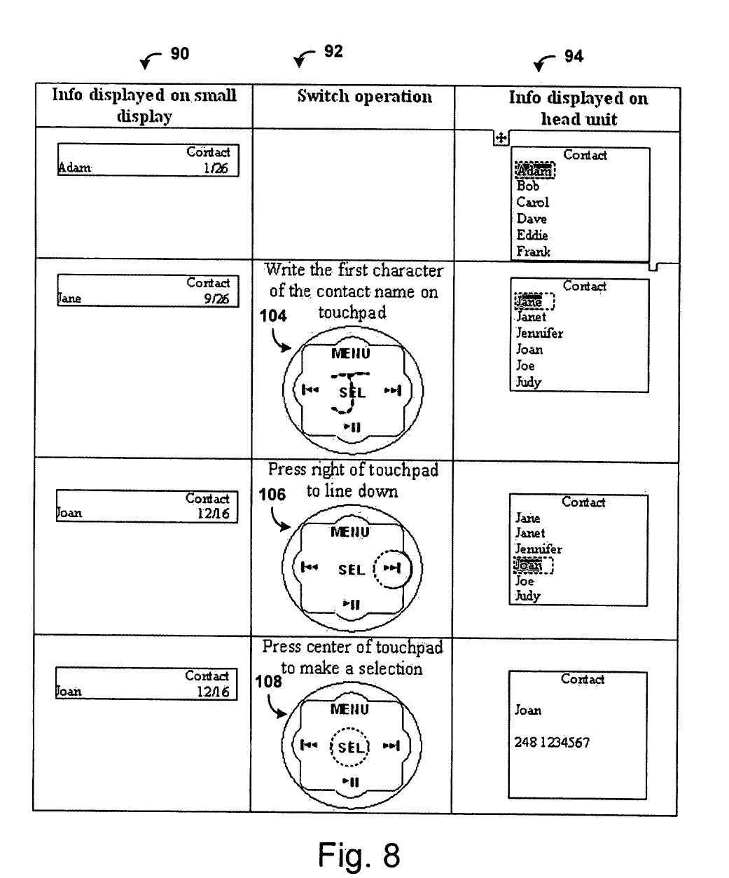

Referring generally to FIGS. 6-8, contents of displays at 90 and 94 change in response to user manipulation of the touchpad during a number entry mode (FIG. 6), a list element selection mode (FIG. 7), and an alphabetized list element selection mode (FIG. 8). For example, number entry by the user can occur by the user shifting focus across the range of displayed digits by touching the touchpad and dragging the focus indicator across the range of digits to the desired digit as at 96. In some embodiments, when the user lifts the finger from the touchpad, the digit having the focus retains the focus, and the user can clearly see which digit has the focus by the focus indicator, which is a display property, such as a highlight, a bounding box, or any change in how the digit is displayed compared to the other digits. Then the user can select that digit by pressing the center of the touchpad as at 98 and lifting the finger away without performing further motion. Alternatively, if the wrong digit retains the focus, the user can change the focus without selecting the digit by using motion instead of a simple press.

List element selection can be used to select a name or number from a list, such as the address book, incoming calls, outgoing calls, or missed calls. For example, the first list element can initially be given the focus, and the user can shift the focus up or down in the list using designated controls or touchpad regions for moving forward or back as at 100. Alternatively or additionally, the user can move through the list using motion on the touchpad. Again, the user can clearly see which of the list elements currently has the focus by the focus indicator, which is a distinguishing display property of the list element having the focus. Then, the user can select the list element having the focus by pressing a designated control or touchpad region, such as the center of the touchpad, as at 102.

Alphabetized list element selection can make use of a user drawn character to search the list. In particular, this mode of search can be useful for searching the cell phone address book. However, it is envisioned that this mode of search can be useful for searching a white pages list of names, a yellow pages list of categories, or a list of available media, such as music or video by title, artist, genre, or playlist. It should be readily understood that these types of contents can be searched in the same manner as the contents of the address book. For example, a first list element in the address book can initially be given the focus, and the contents of the address book can be partially displayed based on the focus. Then, the user can enter a hand drawn letter on the touchpad as at 104 which, when recognized, causes the focus to be shifted to the first list element that begins with that letter. The display can change accordingly, and the user can clearly see which list element currently has the focus. The user can subsequently shift the focus up or down in the list as at 106, thus changing the display. In various embodiments, the user can use motion to shift the focus, and/or can shift the focus by manipulating designated controls for moving forward and backward in an incremental fashion. Again, the user can clearly see which element has the focus, and select the list element having the focus by pressing a designated control or touchpad region, such as the center of the touchpad, as at 108.

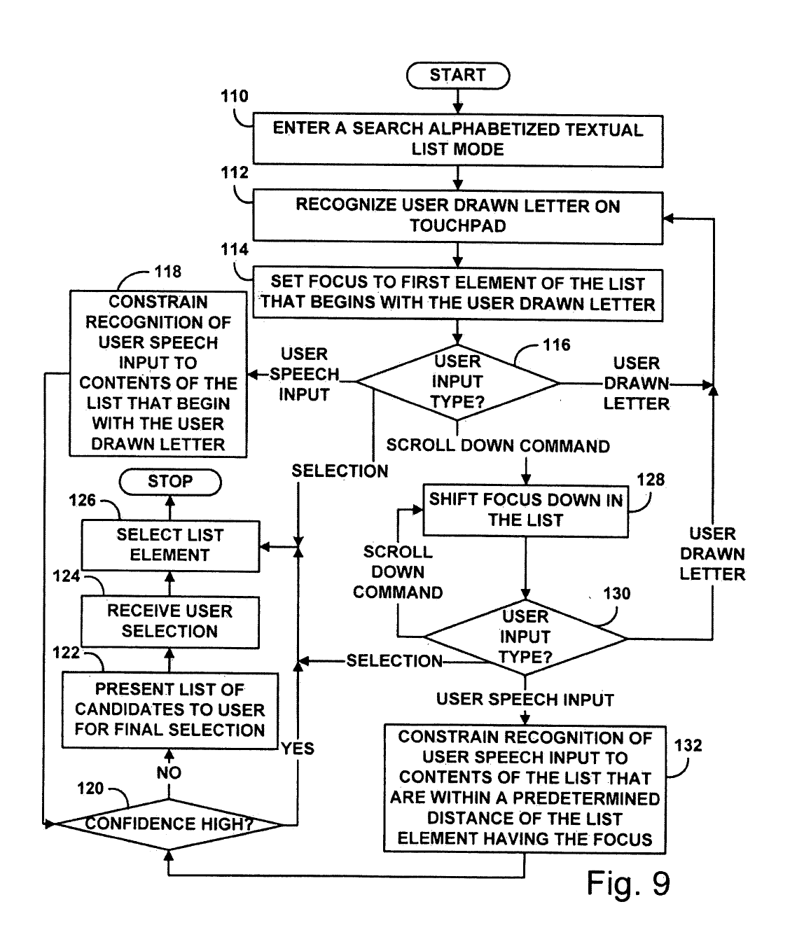

Turning now to FIG. 9, it is envisioned that the alphabetized list search mode can be supplemented with search by user speech input. For example, beginning at step 110, an alphabetized textual list search mode is entered by the user selecting to search a list of alphabetized or otherwise ordered contents (e.g., numbers of several digits), such as an address book, white pages, yellow pages, or media. Then, a user hand drawn letter or character on the touchpad is recognized at step 112. Next, the focus is set to the first element of the list that begins with that letter or character at step 114. It should be readily understood that the element having the focus is displayed so that the user can determine at least whether the letter or character was correctly recognized. Further operation depends on the type of input next supplied by the user.

Once the focus has been set to the first list element that begins with the user supplied letter, it is possible that the user wishes to select that element. In this case, the user can simply select that element at step 126 by pressing a designated control or touchpad region, such as the center of the touchpad. However, it is also possible that the item the user wishes to select does not yet have the focus, and may not be displayed at all because it is too far down the list. Yet, the user may not wish to scroll down and find the element. In this case, armed with the knowledge that the letter was correctly recognized, the user can simply speak the name of the desired list element. In this case, speech recognition is performed on the user speech input at 118 with the recognition being constrained to contents of the list that begin with the user drawn letter or character. In other words, if the user entered the letter “J,” thus causing the focus to be set to the first name, Jane, that starts with the letter “J”, then the user could speak the name, “Joan,” and have the recognition of that speech input constrained to all names in the list that start with the letter “J.” If the confidence is high for one element in those contents at decision step 120 (i.e., significantly higher for one element than for any other of those elements), then the focus can be shifted to that element and that element automatically selected at step 126. However, if the confidence is not high enough to select a single list element, then the best candidates from those contents can be presented to the user at step 122 for final selection at step 124, leading to selection of the finally selected candidate at step 126.

There are still two other types of input that the user can provide at decision step 116. For example, the user could realize that the hand drawn letter or character was not recognized correctly. In this case, the user could simply draw the letter or character again, causing return to step 112. In some embodiments, return to step 112 leads to the letter or character being recognized with a constraint that it is not the one previously identified. Knowledge at this stage of the previous misrecognition can additionally be used to train the recognition models. Also, another input that the user might provide is a scroll down command by pressing a designated control. Some embodiments do not use motion on the touchpad for scrolling up or down elements in an alphabetized list in order to avoid confusion with user drawn letters or characters. However, other embodiments can allow hand drawn letters or characters in one region of the touchpad, and motion for scrolling in another region of the touchpad. In the case the user chooses to scroll, the focus is shifted down the list at step 128, and the display changes accordingly. It is envisioned that the contents of the display will change in this case, and the next operation depends on the type of input next received from the user.

If the user chooses to scroll down so that contents of the display are changed, the manner in which a user speech input is processed is changed, while processing of the other types of user inputs (i.e., manual selection, user drawn letter, or scroll down command) remain the same. The difference in how the user speech input is processed lies in the assumption that the user has scrolled down until the desired list element is displayed, but the user does not wish to scroll precisely to and manually select the desired element. Accordingly, recognition of the user speech input after the user has scrolled the display is constrained to the displayed contents of the list. In other words, the recognition is constrained to contents of the list that are within a predetermined distance of the list element having the focus, with the distance being selected based on the number of list elements near the focus that can be displayed concurrently. It is envisioned that a search backwards though the list can be used if the resulting recognition confidence is especially low. This search backwards can be based on the assumption that the user scrolled too far past the desired list element. The search backwards can be stopped at the first element that starts with the user drawn letter or character. It is additionally or alternatively envisioned that a low confidence can result in performance of step 118 on the assumption that the user scrolled accidentally or changed his or her mind before reaching the desired list element. Accordingly, the scrolling behavior of the user can be used to constrain the speech recognition to a portion of the list contents, and resulting confidence levels can be used to decide whether to employ alternative constraint criteria.

As mentioned above, it is envisioned that various types of contents can be searched, including cell phone contents, media player contents, automobile hard disc contents, removable disc contents, and/or Internet contents. It is further envisioned that the cell phone can have a media player function, and can even store video media that can be selected and played using a console display or heads up display of the vehicle. The same can be accomplished with video media played from an iPod™, streamed from satellite or the Internet, or played from hard disc or removable disc or other storage or media source of the vehicle. In the case of an iPod™ or cell phone, it is envisioned that a docking station can be used to transfer the video data to a video media player of the vehicle at a fast rate. It is also envisioned that video from the cell phone can be supplied to the video player of the vehicle by Bluetooth connection, with buffering of video data as required to allow the video to be played at a decent frame rate. This process can involve completely downloading the video media from the cell phone to a hard disc storage of the vehicle media player before commencing play of the video. Alternatively, the quality of the display (e.g., frame rate) can be sacrificed to allow for real time steaming, as in the case of a video phone call. Yet, it is further envisioned that the speed of the Bluetooth connection can increase in the future to allow high quality streaming of video data.

What is claimed is:

1. A system for controlling cellular telephone from within a vehicle, comprising:
a cell phone interface disposed within the vehicle and configured to establish data communication with a cellular telephone disposed within the vehicle;
a touchpad supplying input from a vehicle occupant including at least motion vectors;
a control unit coupled to said cell phone interface that effects data communication with said cellular telephone via said cell phone interface at least in part in response to the motion vectors.

2. The system of claim 1, further comprising a display disposed within the vehicle and coupled to said control unit, wherein said display communicates to the occupant at least one of: (a) status of a user input operation accomplished by one or more of the motion vectors; or (b) contents of the cell phone.

3. The system of claim 2, further comprising a character recognition system coupled to the touchpad and the control unit for causing the control unit to selectively interact with said cellular telephone based on hand-drawn characters supplied by the vehicle occupant using said touchpad.

4. The system of claim 3, wherein said control unit searches contents of the cellular telephone by user drawn character.

5. The system of claim 4, wherein said control unit searches the contents by constraining a speech input supplied by the occupant to a portion of the contents identified by the user drawn character.

6. The system of claim 5, wherein said control unit searches the contents by further constraining the speech input to a further portion of the contents identified by input supplied by the occupant in order to scroll through the portion of the contents identified by the user drawn character.

7. The system of claim 2, wherein said control unit searches contents of the cell phone in response to input received from the vehicle occupant.

8. The system of claim 7, wherein said control unit searches a particular portion of cell phone contents in response to input selecting to search that particular portion.

9. The system of claim 8, wherein said control unit automatically employs one of plural search methods in response to selection of a type of contents to search.

10. The system of claim 2, further comprising a number dialer displaying a range of numerical digits to the vehicle occupant with a focus on one of the digits being shifted across the range by one or more of the motion vectors, a display property indicating the focus to the vehicle occupant, the focus being used to select numbers for concatenation in a dialing sequence to be used in operating the cellular telephone.

11. The system of claim 2, wherein said display functions as a media viewer to display media content stored in at least one of: (a) the cellular telephone; (b) a media player attached to a vehicle audio system; or (c) a media storage system integrated with the vehicle audio system.

12. The system of claim 11, wherein said display is a primary visual display of a vehicle navigation system, and is employed to display streaming video media.

14. The system of claim 2, wherein said visual display presents menu navigation choices and phonebook choices to the user, wherein navigation is performed using the touchpad.

14. The system of claim 1, wherein said cell phone interface is a Bluetooth connection.

15. The system of claim 1, wherein said system performs menu navigation, incoming call receiving, outgoing call dialing, and media play/search.

16. The system of claim 1, further comprising ECU or PC software in order to: (a) host phone control logic and control Bluetooth cell phone based on switch input; (b) host OCR engine, read and interpret switch action; (c) use recognized character/motion to search audio/BT phone database; and (d) send information for display units and information for voice feedback to a head unit in a cell phone control mode.

17. The system of claim 1, further comprising a head unit to: (a) host audio control logic and drive a radio based on switch input; (b) interface to a media player to search based on a character from switch input; (c) drive an LCD display and a secondary display; and (d) generate voice feedback.

18. The system of claim 1, wherein said system provides control of the cellular telephone including: (1) control multimedia and search program by multiple methods; (2) receive/make/terminate calls by various methods; (3) use organizer and email software.

19. The system of claim 1, wherein said system performs data search using the touchpad with finger-writing character input capability.

20. The system of claim 1, further comprising a secondary display in view of the vehicle occupant, and a dialogue module providing voice feedback to assist menu navigation and control operations.

21. The system of claim 1, further comprising a dialogue module providing voice feedback to assist the user in operating the cell phone via the touchpad.

22. The system of claim 1, wherein said system supports cell phone operations include at least one of phone calls, multimedia, or organizer and Internet connection operations.

23. The system of claim 22, wherein supported phone call operations include at least one of: (a) receiving incoming calls; (b) making a call by inputting one or more of a phone number by each digit, browsing and searching an address book, and browsing and searching call history (incoming, outgoing, missed calls); (c) terminating a call and canceling an outgoing call before connection is established; (d) muting and un-muting an audio system automatically depending on cellular telephone status; (e) viewing incoming text messages; (f) sending text messages; and (g) synchronizing the address book and call history dynamically between software of the vehicle and the cell phone.

24. The system of claim 22, wherein supported multimedia operations include at least one of: (a) controlling an mp3 player on the cellular telephone and searching mp3 files by multiple search methods through Internet mp3 browser software; (b) controlling a radio on the cellular telephone and seeking different stations in AM/FM/Satellite; (c) controlling a TV on the cellular telephone and seeking different stations including satellite TV stations; (d) controlling a video player on the cellular telephone and searching for a video program to play; (e) controlling a camera on the cellular telephone to snap a picture and send the picture; or (f) playing games on the cellular telephone.

25. The system of claim 22, wherein supported organizer and Internet connection operations include at least one of: (a) viewing an incoming email; (b) composing and sending an email by browsing and searching inbox emails and/or browsing and searching a contact list; (c) viewing a calendar and tasks; (d) composing a document using document composing software on the cellular telephone; (e) surfing the Internet, reading news, downloading music, receiving dynamic, topically focused messages and viewing the messages; or (f) playing online games.

26. A method for controlling cellular telephone from within a vehicle, comprising:
establishing data communication with a cellular telephone disposed within the vehicle;
supplying input from a vehicle occupant including at least motion vectors; and
effecting data communication with said cellular telephone at least in part in response to the motion vectors.

27. The method of claim 26, further comprising displaying to the occupant at least one of: (a) status of a user input operation accomplished by one or more of the motion vectors; or (b) contents of the cell phone.

28. The method of claim 27, further comprising recognizing a hand drawn character based on the motion vectors and selectively interacting with the cellular telephone based on the hand-drawn characters supplied by the vehicle occupant.

29. The method of claim 28, further comprising searching contents of the cellular telephone by the user drawn character.

30. The method of claim 29, further comprising searching the contents by constraining recognition of a speech input supplied by the occupant to a portion of the contents identified by the user drawn character.

31. The method of claim 30, further comprising constraining recognition of the speech input to a further portion of the contents identified by input supplied by the occupant in order to scroll through the portion of the contents identified by the user drawn character.

32. The method of claim 27, further comprising searching contents of the cell phone in response to input received from the vehicle occupant.

33. The method of claim 32, further comprising searching a particular portion of cell phone contents in response to input selecting to search that particular portion.

34. The method of claim 33, further comprising automatically employing one of plural search methods in response to selection of a type of contents to search.

35. The method of claim 27, further comprising:
displaying a range of numerical digits to the vehicle occupant with a focus on one of the digits being shifted across the range by one or more of the motion vectors;
employing a display property to indicate the focus to the vehicle occupant;
using the focus to select digits for concatenation in a dialing sequence; and
using the dialing sequence to operate the cellular telephone.

36. The method of claim 27, further comprising:
displaying menu navigation choices and phonebook choices to the user; and
performing navigation in response to the motion vectors.

37. The method of claim 27, further comprising displaying media content stored in at least one of: (a) the cellular telephone; (b) a media player attached to a vehicle audio system; or (c) a media storage system integrated with the vehicle audio system.

38. The method of claim 26, further comprising:
obtaining visual media from the cell phone via said device interface; and
displaying the visual media via a primary display of a vehicle navigation system of the vehicle.

39. A system for displaying video media within a vehicle, comprising:
a vehicle entertainment system having a head end controlling operation of a video media display device disposed within the vehicle;
a device interface disposed within the vehicle and configured to establish data communication with a media device disposed within the vehicle; and
a user interface responsive to input from an occupant of the vehicle to browse visual media available via the media device and to commence delivery of the video media from the media device to the video media display device via said device interface and said head end.

40. The system of claim 39, wherein said head end delivers the video media via a primary display of a vehicle navigation system of the vehicle.

41. The system of claim 39, wherein said user interface obtains a copy of index data from the media device via said device interface and browses the copy in response to the input from the occupant of the vehicle by displaying filtered portions of the copy on at least one of the display device of the head end or a secondary display device of the head end.

42. The system of claim 39, wherein said user interface employs said device interface to interactively query the media device for filtered index data and receive filtered data from the media device, and displays the filtered data on at least one of the visual display device of the head end or a secondary display device of the head end.

43. The system of claim 39, wherein said device interface is a wired connection.

44. The system of claim 43, wherein said wired connection is a docking station for the media device.

45. The system of claim 39, wherein said device interface is a wireless connection.

46. The system of claim 45, wherein said wireless connection is a Bluetooth connection.

47. The system of claim 39, wherein said media device stores the visual media thereon in persistent computer memory.

48. The system of claim 39, wherein said media device obtains the visual media by streaming wireless connection.
